(19) United States
(12) Patent Application Publication
(10) Pub. No.: US 2014/0310690 A1
(43) Pub. Date: Oct. 16, 2014

(54) System and Method for Generating Automated Test Cases for Command Line Based Applications

(71) Applicant: FUTUREWEI TECHNOLOGIES, INC., Plano, TX (US)

(72) Inventor: Bai Yang, Cupertino, CA (US)

(73) Assignee: FutureWei Technologies, Inc., Plano, TX (US)

(21) Appl. No.: 13/863,185

(22) Filed: Apr. 15, 2013

(51) Int. Cl. G06F 11/36

(52) U.S. Cl. CPC G06F 11/3684
USPC 717/124

(57) ABSTRACT

System and method embodiments are provided for creating automated test cases for an application or software command based on knowledge about the application command. An embodiment method includes reading general knowledge about a plurality of application commands from a global knowledge base for the application commands, reading local knowledge about the application command from a local knowledge base corresponding to the application command, identifying, in a syntax file of the application command, a plurality of command options and command variables, determining which of the command options to include in a test case, and replacing the command variables and any included command options in the test case with test values according to the local knowledge and the general knowledge.

### TECHNICAL FIELD

The present invention relates to software testing, and, in particular embodiments, to a system and method for generating automated test cases for command line based applications.

### BACKGROUND

Commercial software is tested by a quality assurance (QA) group or agent before release to customers. For example, regression test and new features test are tests that are run for each release. A test framework is an environment which the QA group/agent uses to run the test cases. These test cases usually include test scripts and expected results. During run-time, test scripts are run in the application and returns the test result back to the test framework. A comparison tool in the test framework compares the actual test result with the expected result and returns a status to the QA group/agent. For QA purpose, enough test cases are needed to cover all the features in the application in order to make sure that the tested software is useable and reliable for end users.

In company environments, automated test cases have been created by QA development teams manually. QA developers need to read reference manuals and understand how to use the commands. The developers then create test matrices to make sure that all or enough options and reasonable combinations of the options are tested. The developers then create test scripts and test them in command line environment. When the test passes successfully, QA developers generate test case files, replace values with variables in test scripts of the files, put the files in the format required by the test framework, and then retest the files in the framework environment. Creating portable and re-useable test cases may require multiple days of development. When the command needs to be tested is complex, it is harder for the developer to create test cases to cover all or enough options and combinations for the command. There is a need for an improved scheme for QA testing that resolves some of the issues above, simplifies test case generation, and provide efficient and re-usable testing.

### SUMMARY OF THE INVENTION

In accordance with an embodiment, a method for generating automated test cases for an application command includes establishing a knowledge base for the application command that includes global knowledge for a plurality of commands and local knowledge about the application command, parsing the application command to identify variable and option parameters in the application command, and replacing, using the knowledge base, at least some of the variable and option parameters with test values to obtain each of the test cases.

In accordance with another embodiment, a method for generating automated test cases for an application command includes reading general knowledge about a plurality of application commands from a global knowledge base for the application commands, reading local knowledge about the application command from a local knowledge base corresponding to the application command, identifying, in a syntax file of the application command, a plurality of command options and command variables, determining which of the command options to include in a test case, and replacing the command variables and any included command options in the test case with test values according to the local knowledge and the general knowledge.

In accordance with yet another embodiment, an apparatus for generating automated test cases for an application command includes a processor and a computer readable storage medium storing programming for execution by the processor. The programming includes instructions to read, from a knowledge base for the application command, global knowledge for a plurality of commands and local knowledge about the application command, parse the application command using a help command to identify variable parameters in the application command, and replace, using the global knowledge and the local knowledge, at least some of the variable parameters with test values to obtain a plurality of test cases.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates an embodiment method for generating test cases for an application or command;

FIG. 2 illustrates an embodiment method for option handling to generate test cases for a command;

FIG. 3 is a processing system that can be used to implement various embodiments.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

System and method embodiments are provided for creating automated test cases for an application based on knowledge about the application. The applications may be a software, program, or code, including one or more computer oriented command lines in any suitable computer language or the like (e.g., pseudo-code). A knowledge base is built for one or more application commands to be tested. The knowledge base can include global knowledge (e.g., about different application commands) as well as local knowledge about the application command that is tested. The embodiments also use the output of a function or command that is applied to application command lines to identify the keywords and options of the command. This function can be a help command, which is currently available in most of the command line applications for developers, such as Structured Query Language (SQL) and Hive in Hadoop. However, any suitable function or command that is currently available (or may be available in future releases) to developers and can serve this purpose may also be used. The help command or function can be used on the application command lines and the resulting output is scanned or parsed to obtain keywords and options (e.g., command variables or parameters) for the application/command. The options are then assigned suitable values to generate test cases, as described below. The output is parsed and the test cases are generated in accordance to the knowledge established in the knowledge base(s).

The test cases for the application or command(s) can be generated automatically by a testing tool, e.g., a program or software, that is configured for this purpose. The tool receives (e.g., reads) the command to be tested as input and returns (e.g., writes) one or more test cases as output. To generate test cases, the tool uses knowledge about the command from one or more knowledge bases, which may include built-in knowledge, global knowledge, and local knowledge, or any combination thereof. The knowledge bases (described further below) may be separate data bases or combined into one or fewer bases. For example, the built-in knowledge and/or the global knowledge may be based on External Specification (ES) or user manual of the application under test. The ES is created by a project manager or developer(s) and includes knowledge about how end users use the application or software. A user manual may include all the knowledge in ES. The local knowledge base includes more specific knowledge about the command that is tested. The information in the knowledge base(s) can be built prior to generating the test cases for the application.

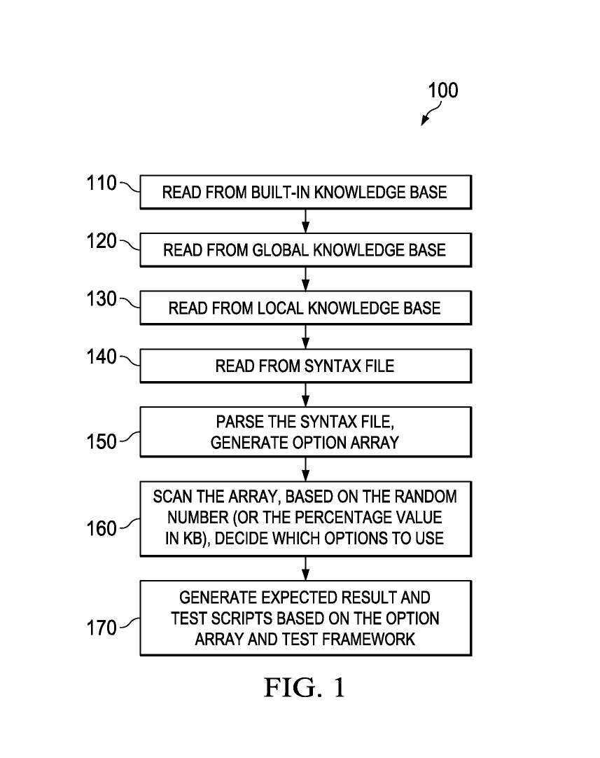

FIG. 1 shows an embodiment method 100 for generating test cases for an application or command. A testing tool, such as a software suite or application, is configured to implement the method 100 to generate one or more test cases, e.g., in an automated manner with no or minimum developer input or intervention (in comparison to current QA testing systems). The tool reads information or knowledge that is relevant or needed for the application or command to be tested from a built-in knowledge base (in step 110), a global knowledge base (in step 120), and a local knowledge base (in step 130).

The built-in knowledge base includes knowledge needed for writing the code of the test tool to generate the test cases. For example, the knowledge includes that a two-byte integer value should be a value between −32768 to 32767. Further, when a user inputs a two-byte integer value, it should be a set of characters 0-9 in addition to “−” and “+”, and “−” and “+” can only be the first character. The naming convention for the application command is also included in this knowledge base. For example, in order to parse a command in the test tool, the parsing function needs to know that when it encounters a “[” character, it needs to find the matching “]” character, and the content between these two characters is an option in the parsed command.

The global knowledge base includes knowledge or information shared by different application/commands. The knowledge is not needed for writing the code of the test tool to generate test cases. An Extensible Markup Language (XML) file (or other suitable file format) can be used to add this knowledge to the testing tool. For example, the global knowledge indicates that a table name (in the application command) should be a string starting with a character ‘a’ to ‘z’ or “_” in addition to other specified or pre-determined characters. The same knowledge may be needed for different commands, such as create table, create view, create index, select, update, and delete commands. If this knowledge is put in a local knowledge base, then there may be significant duplicate information in local knowledge bases corresponding to the different commands. If duplicating the information in different local knowledge bases is acceptable, then the information of the global knowledge base can be put instead in the local knowledge bases. However, saving this shared information in a global knowledge base is more efficient (e.g., to save storage and process time). The information of the built-in knowledge base on the other hand is not put in the local knowledge base for the test tool since this information is already available and used in test tool prior to testing (prior to configuring the test tool).

The local-knowledge base includes knowledge or information specific to the application commander that is tested. The steps 120 and 130 can be implemented in any order. In another embodiment, steps 120 and 130 can be combined to read global/local knowledge from a single data base. However, step 110 is implemented first to establish or read the built-in knowledge to write the test tool's code. Subsequently, the global/local knowledge is read to parse the application command and generate test cases. The knowledge bases are previously established. However, in another embodiment, one or more of the knowledge bases can be created during the implementation or the test case generation process. For example, the local knowledge base can be created in step 130.

The tool then reads (in step 140) information in the command, such as keywords and options, from an output (e.g., a syntax file) generated using a help (or similar) command on the tested command. The help command reads the tested command as input and returns the output or syntax file as output. Alternatively, the output or syntax file is generated in step 140. The tool then parses the output or syntax file (in step 150) and generates an option array. During the parsing process, the tool gets keywords and options in the command. The tool can use the knowledge base(s) (e.g., in steps 110, 120, and 130) to parse the output file using the help command. The knowledge may include syntax conventions such as:

Upper case: Keyword in the command
Lower case: Variable in the command
Curly brackets { }: Command options
Square brackets [ ]: Optional arguments
Ellipsis “...”: repetition of a command
Pipe “|”: “OR” relationship

At step 160, the tool scans the array and decides which option(s) to use, for instance based on generating a random number or based on a pre-determined percentage value for option usage. At step 170, the tool generates expected result and test script(s) based on the option array and test framework. During this step, the tool converts the options in the command to real values based on the information in the knowledge base. More details about the steps of method 100 are described below.

In an example, a “create table” command in a SQL application is tested. The “create table” command is parsed using the help command in SQL (e.g., in step 140 of method 100) providing the following output syntax file:

```
pterodb=\h create table
Command:  CREATE TABLE
Description: define a new table
Syntax:
CREATE [ [ GLOBAL | LOCAL ] { TEMPORARY | TEMP }
| UNLOGGED ] TABLE [ IF NOT EXISTS ] table_name (
[
  { column_name data_type [ DEFAULT default_expr ]
[ column_constraint [ ... ] ]
  | table_constraint
  | LIKE parent_table [ like_option ... ] }
  [, ... ]
] )
[ INHERITS ( parent_table [, ... ] ) ]
[ WITH ( storage_parameter [= value] [, ... ] ) | WITH OIDS |
WITHOUT OIDS ]
[ ON COMMIT { PRESERVE ROWS | DELETE ROWS | DROP } ]
[ TABLESPACE tablespace ]
[ DISTRIBUTE BY { REPLICATION | ROUND ROBIN | { [HASH |
MODULO ] ( column_name ) } } ]
[ TO ( GROUP groupname | NODE nodename [, ... ] ) ]
CREATE TABLE table_name
  OF type_name [ (
  { column_name WITH OPTIONS [ DEFAULT default_expr ]
[ column_constraint [ ... ] ]
  | table_constraint }
  [, ... ]
) ]
[ WITH ( storage_parameter [= value] [, ... ] ) | WITH OIDS |
WITHOUT OIDS ]
[ ON COMMIT { PRESERVE ROWS | DELETE ROWS | DROP } ]
[ TABLESPACE tablespace ]
[ DISTRIBUTE BY { REPLICATION | ROUND ROBIN | { [HASH |
MODULO ] ( column_name ) } } ]
[ TO ( GROUP groupname | NODE nodename [, ... ] ) ]
where column_constraint is:
[ CONSTRAINT constraint_name ]
{ NOT NULL |
  NULL |
  CHECK ( expression ) |
  UNIQUE index_parameters |
  PRIMARY KEY index_parameters |
  REFERENCES reftable [ ( refcolumn ) ] [ MATCH FULL |
  MATCH PARTIAL | MATCH SIMPLE ]
  [ ON DELETE action ] [ ON UPDATE action ] }
[ DEFERRABLE | NOT DEFERRABLE ] [ INITIALLY DEFERRED |
INITIALLY IMMEDIATE ]
and table_constraint is:
[ CONSTRAINT constraint_name ]
{ CHECK ( expression ) |
  UNIQUE ( column_name [, ... ] ) index_parameters |
  PRIMARY KEY ( column_name [, ... ] ) index_parameters |
  FOREIGN KEY ( column_name [, ... ] ) REFERENCES
  reftable [ ( refcolumn [, ... ] ) ]
  [ MATCH FULL | MATCH PARTIAL | MATCH SIMPLE ] [ ON
  DELETE
  action ] [ ON UPDATE action ] }
[ DEFERRABLE | NOT DEFERRABLE ] [ INITIALLY DEFERRED |
INITIALLY IMMEDIATE ]
and like_option is:
{ INCLUDING | EXCLUDING } { DEFAULTS | CONSTRAINTS |
INDEXES | STORAGE | COMMENTS | ALL }
index_parameters in UNIQUE and PRIMARY KEY constraints are:
[ WITH ( storage_parameter [= value] [, ... ] ) ]
[ USING INDEX TABLESPACE tablespace ]
pterodb=#
```

There are five sections in the above output from using the help command to process the “create table” command. The first two sections include two create table commands. The remaining sections include information about the column_constraint, table_constraint, and like_option. The two create table commands can be used as input to create automated test cases, as described further below. However, knowledge about the “create table command” is needed before generating the automated test cases. For the first of two create table commands, a plurality of options are found, including table type option (data type), table name option, exists option, column definition options, inherits option, with option, on commit option, tablespace option, distribute by option, and to option. For the second option in this list, the knowledge of the table name is needed. For the fourth option, the knowledge of the column name, parent table, and data type is needed. This information needs to be in a knowledge base. For example, this information is read from a local knowledge base (e.g., in step 130 of method 100), before creating the test cases.

For example, an XML script can be used to present, in the local knowledge base, the knowledge about table name, column name, and the other needed information above. For example, the knowledge indicates that the data type needs to be one of the data types that are supported and the parent table needs to be a name of a pre-created table on the system. Additionally, if the on commit option is used, then a temp or temporary option is set to “true” and if the distribute by option is used, then the inherits option is set to “false”. The XML script can have the following form:

<table_name attribute=“UniqueString”>
<Prefix>tab</prefix>
</table_name>
<column_name attribute=“UniqueString”>
<Prefix>col</prefix>
</column_name>
<data_type attribute=“List”>
bigint, bigserial, bit [ (n) ], bit varying [ (n) ] , boolean , box , bytea ,
character varying [ (n) ] , character [ (n) ] , cidr , circle , date , double
precision , inet , integer , interval [ fields ] [ (p) ] , line , lseg , macaddr ,
money , numeric [ (p, s) ], path, point, polygon, real, smallint, serial,
text, time [ (p) ] [ without time zone ], time [ (p) ] with time zone,
timestamp [ (p) ] [ without time zone ], timestamp [ (p) ] with time
zone, tsquery, tsvector, txid_snapshot, uuid, xml
</data_type>
<parent_table attribute=“List”>
testtab1, testtab2, testtab3
</parent_table>
<ON_COMMIT attribute=“Rule”>
<pre_requisite>TEMPORARY or TEMP is true</pre_requisite>
</ON_COMMIT>
<DISTRIBUTE_BY attribute=“Rule”>
<pre_requisite>INHERITS is false</pre_requisite>
</DISTRIBUTE_BY>

After creating or obtaining the knowledge above, the “create table” command can be processed or parsed by the help command using this knowledge to provide the output syntax file described above. The information in the output file can then be divided (e.g., as part of step 150 of method 100) to keywords, variables, and options. Dividing the information can be in the following form:

| | |
|---|---|
| 1. | CREATE |
| 2. | [ GLOBAL \| LOCAL ] { TEMPORARY \| TEMP } \| UNLOGGED |
| 3. | TABLE |
| 4. | IF NOT EXISTS |
| 5. | table_name |
| 6. | ( |
| 7. | { column_name data_type [ DEFAULT default_expr ] |
| | [ column_constraint [ ... ] ] |
| | \| table_constraint |
| | \| LIKE parent_table [ like_option ... ] |
| | } |
| | [, ... ] |
| 8. | ) |
| 9. | INHERITS ( parent_table [, ... ] ) |
| 10. | WITH ( storage_parameter [= value] [, ... ] ) \| WITH OIDS \| |
| | WITHOUT OIDS |
| 11. | ON COMMIT { PRESERVE ROWS \| DELETE ROWS \| |
| | DROP } |
| 12. | TABLESPACE tablespace |
| 13. | DISTRIBUTE BY { REPLICATION \| ROUND ROBIN \| { [HASH \| |
| | MODULO ] ( column_name ) } } |
| 14. | TO ( GROUP groupname \| NODE nodename [, ... ] ) |

In the information above, “CREATE”, “TABLE”, “(” and “)” are the keywords in the command, while “table_name” and “column_name” are the variables in the command. The other information includes the options for the command. According to the information, the column name definition can occur multiple times (e.g., defining the column name is repeatable), while the other information can occur once. After obtaining this knowledge or information about the “create table” command, the information can be put in an internal array, for instance as shown in Table 1.

TABLE 1

| Num | Type | String | Repeatable |
|---|---|---|---|
| 1 | K | CREATE | N |
| 2 | O | [ GLOBAL \| LOCAL ] { TEMPORARY \| TEMP } \| UNLOGGED | N |
| 3 | K | TABLE | N |
| 4 | O | IF NOT EXISTS | N |
| 5 | V | table_name | N |
| 6 | K | ( | N |
| | | { column_name data_type [ DEFAULT default_expr ] | |
| | | [ column_constraint [ ... ] ] \| table_constraint \| LIKE parent_table | |
| 7 | O | [ like_option ... ] } | Y |
| 8 | K | ) | N |
| 9 | O | INHERITS ( parent_table [, ... ] ) | N |
| | | WITH ( storage_parameter [= value] [, ... ] ) \| WITH OIDS \| | |
| 10 | O | WITHOUT OIDS | N |
| 11 | O | ON COMMIT { PRESERVE ROWS \| DELETE ROWS \| DROP} | N |
| 12 | O | TABLESPACE tablespace | N |
| | | DISTRIBUTE BY { REPLICATION \| ROUND ROBIN \| { [HASH \| | |
| 13 | O | MODULO ] ( column_name ) } } | N |
| 14 | O | TO ( GROUP groupname \| NODE nodename [, ... ] ) | N |

In Table 1, items 2, 7, 9, 10, 11, 13, and 14 have options. In an embodiment, an option handling function can be used to process these options and determine possible values that can be assigned. For example, option number 2 in Table 1 can be further divided as shown in Table 2. For this option, there can be six possible values for the table type, which are “ ” (no specified type), “UNLOGGED”, “GLOBAL TEMPORARY”, “LOCAL TEMPORARY”, “GLOBAL TEMP” and “LOCAL TEMP”.

TABLE 2

| | | | |
|---|---|---|---|
| 2.1 | O | [ GLOBAL \| LOCAL ] { TEMPORARY \| TEMP } | N |
| 2.2 | O | UNLOGGED | N |
| 2.1.1 | O | [ GLOBAL \| LOCAL ] TEMPORARY | N |
| 2.1.2 | O | [ GLOBAL \| LOCAL ] TEMP | N |
| 2.1.1.1 | O | GLOBAL TEMPORARY | N |
| 2.1.1.2 | O | LOCAL TEMPORARY | N |
| 2.1.2.1 | O | GLOBAL TEMP | N |
| 2.1.2.2 | O | LOCAL TEMP | N |

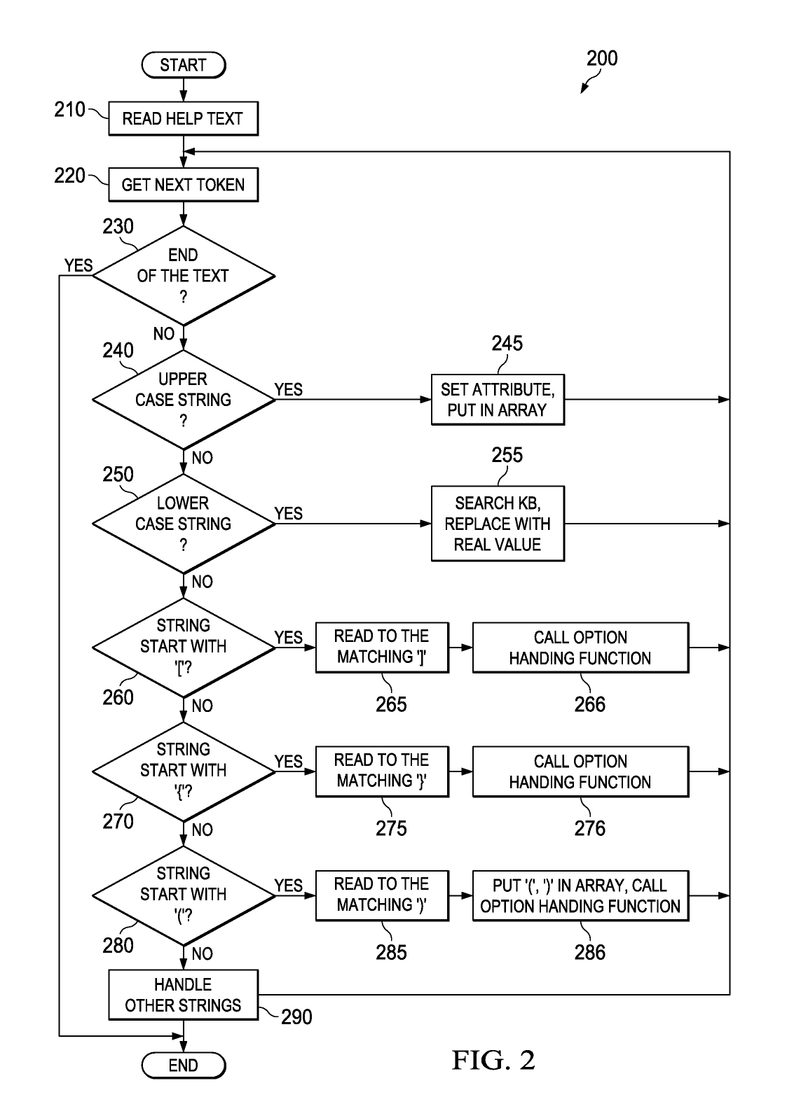

FIG. 2 illustrates an embodiment method 200 for implementing the option handling function that processes the options of the command and determines possible values that can be assigned. The method 200 includes further detailed steps of the step 150 above. At step 210, the output file from using the help command on the tested command (e.g., the “create table” command) is read. At 220, the function gets the next token, e.g., a character or string of characters in the command lines. If the token indicates end of text (step 230), then the method 200 ends. Otherwise, if the token indicates an upper case string (step 240), then the function sets an attribute and puts it in an option array (step 245). Alternatively, if the token indicates a lower case string (step 250), then the function searches a knowledge base and replaces the token with a real value (step 255). If the token is a string starting with a square bracket “[” (step 260), then the function reads the matching bracket “]” in the output file (step 265) and calls the option handling function in a sub-routine (step 266) to parse the text between the brackets. If the token is a string starting with a curly bracket “{” (step 270), then the function reads the matching bracket “}” in the output file (step 275) and calls the option handling function in a sub-routine (step 276) to parse the text between the brackets. If the token is a string starting with a parenthesis “(” (step 280), then the function reads the matching parenthesis “)” in the output file (step 285) and calls the option handling function in a sub-routine (step 286) to parse the text between the parentheses. Otherwise, the function handles other types of strings appropriately (in step 290). After handling the token, the function returns to reading the next token.

The same analysis can be used for the other options. After generating all possible values for all options in the “create table” command, the tests cases can be generated. One scheme to generate the test cases comprises generating first a random number that determines which option(s) to use in the command. When generating the test cases, in addition to using random numbers, the values 0 and 1 may be used to allow the group of generated test cases to include none of the options (e.g., for number 0) and all the options (e.g., for number 1). For the rest of the test cases, the generated random number indicates which combination of options to use. In another scheme, each option is assigned a value in the local knowledge base that indicates the percentage usage of that option of all considered test cases. For example, if the knowledge base indicates that 80% of the test cases should use the “distribute by” clause, then the “distribute by” option is selected in 80% of all the test cases.

Since the test cases are generated automatically by the testing tool, various combinations of options can be easily covered in test cases. Creating the test cases using the internal array (e.g., as in Tables 1 and 2) may also ensure having successful test results without erroneous values. The following are examples of the test cases generated as described above for the “create table” command:

Should return: $$CREATE TABLE$$
Create table tab0 ( );
Should return: $$CREATE TABLE$$
Create unlogged table tab2 ( );
Should return: $$CREATE TABLE$$
Create global temporary table tab3 ( );
Should return: $$CREATE TABLE$$
Create local temporary table tab4 ( );
Should return: $$CREATE TABLE$$
Create global temp table tab5 ( );
Should return: $$CREATE TABLE$$
Create local temp table tab6 ( );
Should return: $$CREATE TABLE$$
Create global temp table tab_all (colbigint bigint, colbox box)
Inherits (testtab1, testtab2)
with oids
on commit drop
tablespace pg_default
distribute by hash (colbigint);

Negative test cases that are expected to provide failure results can also be generated. Similar to the test cases of the “create table” command, test cases can be generated by the testing tool for other commands. The tool can generate test cases for commands in different applications, for example SQL, Hadoop Hive, HBase or other applications. For instance, in the output of the “create table” using the help command in Hive can have the following form:

CREATE [EXTERNAL] TABLE [IF NOT EXISTS] table_name
[(col_name data_type [COMMENT col_comment], ...)]
[COMMENT table_comment]
[PARTITIONED BY (col_name data_type
[COMMENT col_comment], ...)]
[CLUSTERED BY (col_name, col_name, ...) [SORTED BY (col_name
[ASC|DESC], ...)] INTO num_buckets
BUCKETS]
[ROW FORMAT row_format]
[STORED AS file_format]
[LOCATION hdfs_path]
[TBLPROPERTIES (property_name=property_value, ...)]
[AS select_statement]
CREATE [EXTERNAL] TABLE [IF NOT EXISTS] table_name
LIKE existing_table_name
[LOCATION hdfs_path]
data_type
: primitive_type
| array_type
| map_type
| struct_type

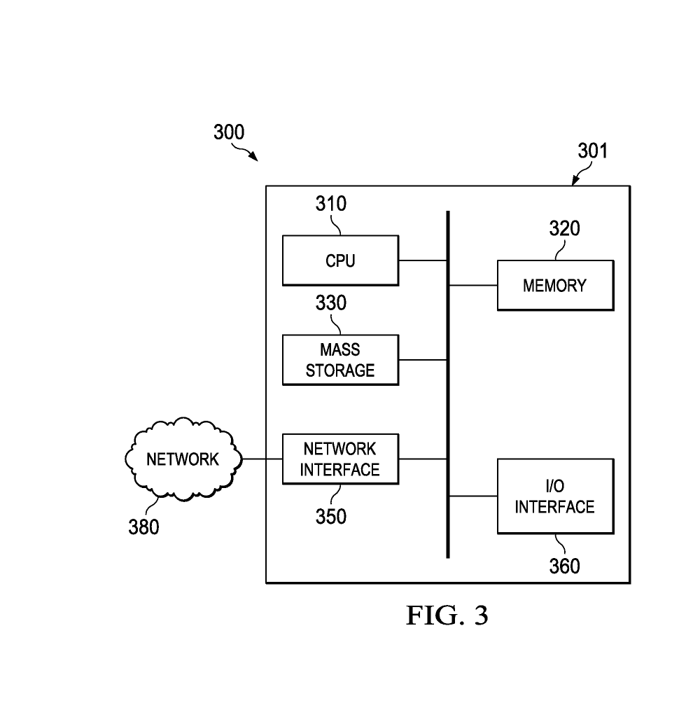

FIG. 3 is a block diagram of a processing system 300 that can be used to implement various embodiments. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system 300 may comprise a processing unit 301 equipped with one or more input/output devices, such as a network interfaces, storage interfaces, and the like. The processing unit 301 may include a central processing unit (CPU) 310, a memory 320, a mass storage device 330, and an I/O interface 360 connected to a bus. The bus may be one or more of any type of several bus architectures including a memory bus or memory controller, a peripheral bus or the like.

The CPU 310 may comprise any type of electronic data processor. The memory 320 may comprise any type of system memory such as static random access memory (SRAM), dynamic random access memory (DRAM), synchronous DRAM (SDRAM), read-only memory (ROM), a combination thereof, or the like. In an embodiment, the memory 320 may include ROM for use at boot-up, and DRAM for program and data storage for use while executing programs. In embodiments, the memory 320 is non-transitory. The mass storage device 330 may comprise any type of storage device configured to store data, programs, and other information and to make the data, programs, and other information accessible via the bus. The mass storage device 330 may comprise, for example, one or more of a solid state drive, hard disk drive, a magnetic disk drive, an optical disk drive, or the like.

The processing unit 301 also includes one or more network interfaces 350, which may comprise wired links, such as an Ethernet cable or the like, and/or wireless links to access nodes or one or more networks 380. The network interface 350 allows the processing unit 301 to communicate with remote units via the networks 380. For example, the network interface 350 may provide wireless communication via one or more transmitters/transmit antennas and one or more receivers/receive antennas. In an embodiment, the processing unit 301 is coupled to a local-area network or a wide-area network for data processing and communications with remote devices, such as other processing units, the Internet, remote storage facilities, or the like.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for generating automated test cases for an application command, the method comprising:
establishing a knowledge base for the application command that includes global knowledge for a plurality of commands and local knowledge about the application command;
parsing the application command to identify variable and option parameters in the application command; and
replacing, using the knowledge base, at least some of the variable and option parameters with test values to obtain each of the test cases.

2. The method of claim 1 further comprising selecting a set of option parameters from the variable and option parameters to include in each of the test cases according to a randomly generated number.

3. The method of claim 1 further comprising selecting which of the option parameters to include in each of the test cases according to a pre-determined usage percentage for each of the options.

4. The method of claim 1, wherein the application command is parsed using syntax convention information that is part of a built-in knowledge base pre-established for writing a code of a test tool that generates the automated test cases for the application command.

5. The method of claim 1, wherein the application command is parsed using a help command that receives the application command as input and provides an output syntax file including the variable and option parameters.

6. The method of claim 1, wherein the variable and option parameters are replaced with test values according to allowed plurality of possible values established in the knowledge base.

7. The method of claim 1, wherein the variable and option parameters include keywords representing functions in the application command, variables representing data structures in the application command, and options that have alternative values for processing the keywords and variables.

8. A method for generating automated test cases for an application command, the method comprising:
reading general knowledge about a plurality of application commands from a global knowledge base for the application commands;
reading local knowledge about the application command from a local knowledge base corresponding to the application command;
identifying, in a syntax file of the application command, a plurality of command options and command variables;
determining which of the command options to include in a test case; and
replacing the command variables and any included command options in the test case with test values according to the local knowledge and the general knowledge.

9. The method of claim 8 further comprising parsing the application command using a help command that outputs the syntax file.

10. The method of claim 8 further comprising establishing an array of the command options from the syntax file by parsing the syntax file according to syntax convention knowledge in the built-in knowledge base.

11. The method of claim 8 further comprising:
reading built-in knowledge from a built-in knowledge base that is used for writing a code of a test tool that generates the automated test cases for the application command; and
using the built-in knowledge with the local knowledge and the general knowledge to replace the command variables and any included command options in the test case with test values.

12. The method of claim 8, wherein at least some of the command variables and any included command options are replaced with suitable values to implement a successful test case.

13. The method of claim 8, wherein at least some of the command variables and any included command options are replaced with invalid values to implement a failed test case.

14. The method of claim 8, wherein the global knowledge and the local knowledge include naming rules and knowledge of alternative values for the command variables and command options.

15. The method of claim 8, wherein determining which of the command options to include in the test case comprises:
assigning different values for different combinations of the command options;
generating a random number; and
selecting one of the combinations to include in the test case by matching the random number to one of the different values assigned for the different combinations.

16. The method of claim 15, wherein the combinations include an empty set for including none of the command options and a complete set for including all the command options.

17. The method of claim 8, wherein determining which of the command options to include in the test case comprises:
assigning a percentage of usage for each of the command options in all considered test cases; and
selecting combinations of the command options in different test cases to meet the percentage of usage for each of the command options.

18. An apparatus for generating automated test cases for an application command, the apparatus comprising:
a processor; and
a computer readable storage medium storing programming for execution by the processor, the programming including instructions to:
read, from a knowledge base for the application command, global knowledge for a plurality of commands and local knowledge about the application command;
parse the application command using a help command to identify variable parameters in the application command; and
replace, using the global knowledge and the local knowledge, at least some of the variable parameters with test values to obtain a plurality of test cases.

19. The apparatus of claim 18, wherein the programming includes further instructions to select which of the variable parameters to include in each of the test cases according to a randomly generated number or a pre-determined usage percentage for each of the variable parameters.

20. The apparatus of claim 18, wherein the application command and the help command are commands in a Structured Query Language (SQL) or Hive platform.
